(19) United States
(12) Patent Application Publication
(10) Pub. No.: US 2005/0225743 A1
(43) Pub. Date: Oct. 13, 2005

(54) Laser range finder having reflective micro-mirror and laser measuring method

(75) Inventors: Jen-Tsorng Chang, Tu-Cheng (TW); Chun-Yu Lee, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/094,374

(22) Filed: Mar. 30, 2005

(30) Foreign Application Priority Data
Apr. 9, 2004 (TW) 93109871

(51) Int. Cl. G01C 3/08

(52) U.S. Cl. 356/5.01; 356/5.13

(57) ABSTRACT

A laser range finder (3) includes an optical source (33) for emitting light beams, a switchable micro-mirror (30) for receiving the light beams and selectively transmitting them to a fixed mirror (40) and a moveable mirror (42) respectively, and a receiver device (50) for collecting the light beams reflected from the fixed mirror and the moveable mirror. The receiver device determines an elapsed time between transmission of the light beams from the fixed mirror and the moveable mirror, and converts the elapsed time into a distance between the moveable mirror disposed at an object and the fixed mirror disposed at a reference point. The switchable micro-mirror may be a micro-electromechanical mirror having high precision, which helps ensure that the laser range finder accurately measures the distance between the reference point and the object.

### BACKGROUND OF THE INVENTION

1. Field of the Invention

The present invention relates to laser range finders, and especially to a laser range finder having a switchable micro-mirror.

2. Prior Art

A range finder is an instrument or device used to determine the distance of an object from a reference point. A laser range finder is an optoelectronic device that operates by sending out laser light pulses and measuring the time it takes for the light to be reflected back by an object or a target. The laser range finder then calculates the distance L to the object based upon the time Td it takes for the light to return to the source and the speed C of light in free space. This theory can be expressed as: Td=2L/C. Currently there are many products of this type on the market, the products being used for hunting, surveying and even golfing.

FIG. 4 is a schematic view of a conventional laser ranger finder 1. The laser ranger finder 1 includes a laser emitter 11, a rotating mirror 10, a fixed optical mirror 20, a moveable optical mirror 22, a third optical mirror 21, and a receiver device 23.

The fixed optical mirror 20 is disposed at a reference point, and the moveable optical mirror 22 is positioned at the object to be measured. In operation, the laser emitter 11 emits measuring laser beams as an optical signal to the rotating mirror 10, and the rotating mirror 10 selectively transmits the optical signal to the fixed optical mirror 20 and the moveable optical mirror 22 respectively. Then, the fixed optical mirror 20 reflects a first optical signal to the third optical mirror 21, and the moveable optical mirror 22 reflects a second optical signal to the third optical mirror 21. The third optical mirror 21 collects the first and second optical signals, and transmits them to the receiver device 23. Finally, the receiver device 23 calculates the distance L between the reference point and the object based upon the equation Td=2L/C, where C is the speed of light in free space, and Td is the elapsed time between transmission of the first and second optical signals from the fixed and moveable optical mirrors 20, 22 respectively.

In order to precisely calculate the distance L, it is important to accurately measure the elapsed time Td. However, the conventional laser ranger finder 1 employs a mechanically operated rotating mirror 10 to transmit laser beams. The rotating mirror 10 is susceptible to mechanical failure or error, such as cracking or misalignment, if it sustains shock or vibration. Thus measuring the elapsed time Td by employing the rotating mirror 10 may be unreliable, and the calculated distance between the reference point and the object may be inaccurate. Further, the rotating mirror 10 is costly to manufacture.

What is needed, therefore, is a laser range finder which can accurately measure a distance and which is inexpensive.

### SUMMARY OF THE INVENTION

A laser range finder for measuring a distance between a reference point and an object of the present invention includes an optical source, a switchable micro-mirror, and a receiver device.

In a preferred embodiment, the laser range finder includes a fixed mirror disposed in a reference point, and a moveable mirror disposed at the object to be measured. The optical source emits laser beams as optical signal, and the switchable micro-mirror receives the optical signal and selectively transmits them to the fixed mirror and the moveable mirror respectively. The receiver device collecting a first optical signal reflected from the fixed mirror and a second optical signal reflected back from the moveable mirror. The receiver device determines an elapsed time between transmission of the first and second optical signals, and converts the elapsed time into a distance between the moveable mirror disposed at an object and the fixed mirror disposed at a reference point.

The laser range finder employs a switchable micro-mirror to output optical signal to the fixed mirror and moveable mirror. The switchable micro-mirror has lower cost and high precision, which ensure the laser range finder accurately measuring the distance between the object and the reference point.

Other objects, advantages, and novel features of the embodiment will become more apparent from the following detailed description when taken in conjunction with the accompanying drawings.

### BRIEF DESCRIPTION OF THE DRAWINGS

FIG. 1 is a schematic, optical path diagram of a laser range finder according to a preferred embodiment of the present invention, the laser range finder including a switchable micro-mirror, a fixed mirror, a moveable mirror and a receiver device.

FIG. 2 is an enlarged, schematic isometric view of the switchable micro-mirror employed in the laser range finder of FIG. 1.

FIG. 3 is a graph showing an elapsed time between a first optical signal received by the receiver device from the fixed mirror and a second optical signal received by the receiver device from the moveable mirror, according to the preferred embodiment.

FIG. 4 is a schematic, optical path diagram of a conventional laser range finder.

### DETAILED DESCRIPTION OF THE INVENTION

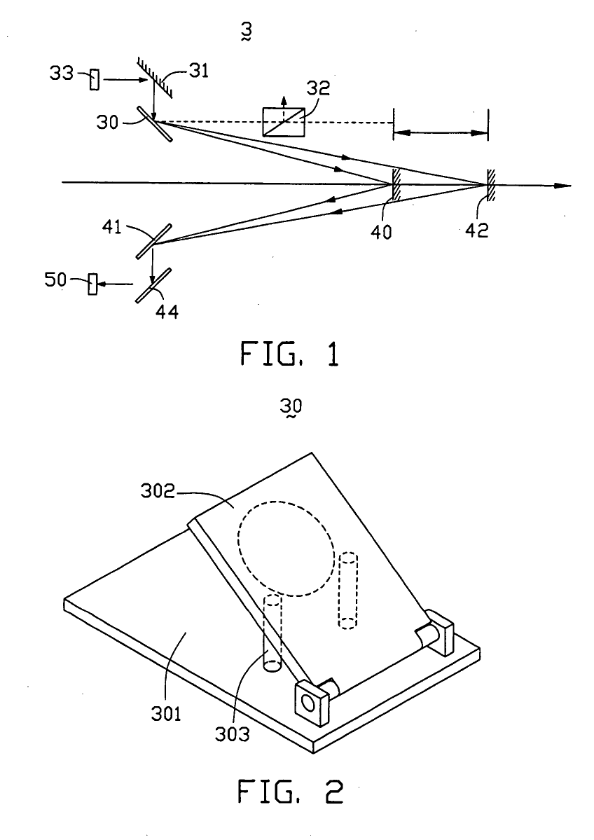

FIG. 1 is a schematic, optical path diagram of a laser range finder 3 according to a preferred embodiment of the present invention. The laser range finder 3 includes an optical source 33, an optical mirror 31, a switchable micro-mirror 30, a detector 32, a fixed mirror 40, optical mirrors 41, 44, a moveable mirror 42, and a receiver device 50.

The optical source 33 can be a laser emitter for emitting laser beams as an optical signal. Further, the optical source 33 is able to emit at least 1 W peak power at 1.55 μm in order to minimize atmospheric scattering.

The optical mirror 31 can be adjusted to reflect the optical signal emitted by the optical source 33 to the switchable micro-mirror 30.

FIG. 2 is a schematic, isometric view of the switchable micro-mirror 30. The switchable micro-mirror 30 includes an optical micro-mirror 302 and a micro-electromechanical system. In the illustrated embodiment, the switchable micro-mirror 30 includes a substrate 301, the optical micro-mirror 302, and support members 303. The optical micro-mirror 302 can be made from silicon. A reflective layer (not labeled) with a high reflecting ratio is coated on the silicon, for reflecting the laser beams. The support members 303 may be made of piezoelectric material, such as a piezoelectric ceramic or polyvinylidene fluoride (PVDF). The support members 303 are connected to an outer controlling circuit (not shown), for electrical control of deformation of the support members 303. When the support members 303 are made of piezoelectric material, this has the characteristic of electromechanical coupling. Accordingly, the support members 303 may be induced to mechanically deform at high speed when an electric field is applied. That is, the support members 303 elongate or contract, so as to oscillate the optical micro mirror 302 at a frequency of 1 KHz˜1.5 KHz. The switchable micro-mirror 30 may be made by LIGA (Lithography Electroforming Micro Molding).

The detector 32 is disposed adjacent to the switchable micro-mirror 30, to ensure that the optical signal reflected by the switchable micro-mirror 30 is powerful enough to be detected by the receiver device 50.

The fixed mirror 40 has a reflective layer (not shown) with a high reflecting ratio coated thereon, the reflective layer facing the switchable micro-mirror 30.

The moveable mirror 42 also has a reflective layer (not shown) with high reflecting ration coated thereon, the reflective layer facing the switchable micro-mirror 30. The moveable mirror 42 may be disposed horizontally from the fixed mirror 40, in which case the moveable mirror 42 is able to horizontally move left and right.

The optical mirrors 41, 44 are disposed below the switchable micro-mirror 30, for receiving the optical signals reflected from the fixed mirror 40 and the moveable mirror 42 respectively, and transmitting the received optical signals to the receiver device 50.

The receiver device 50 can detect the optical signals received from the optical mirror 44. The receiver device 50 includes a processor (not shown), for determining an elapsed time between transmission of the optical signals reflected back from the fixed mirror 40 and the moveable mirror 42, and converting the elapsed time into a distance.

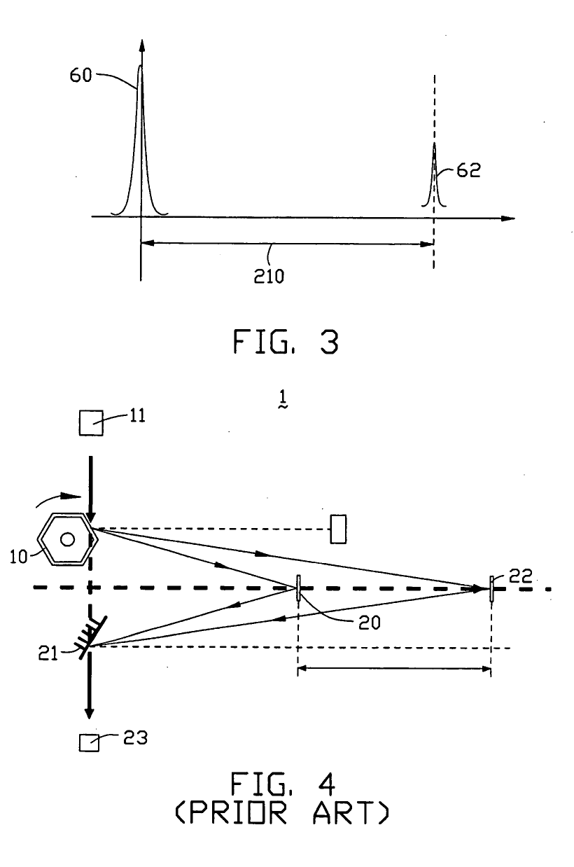

In use and operation, the fixed mirror 40 is disposed at a reference point away from an object, and the moveable mirror is disposed at the object, with the distance between the reference point and the object being the distance to be measured. The optical source 30 emits laser beams as an optical signal, and the optical mirror 31 focuses the optical signal to the switchable micro-mirror 30. The switchable micro-mirror 30 selectively transmits the optical signal to the fixed mirror 40 and the moveable mirror 42 respectively by oscillating the optical micro mirror 302. The fixed mirror 40 reflects a first optical signal 60 back to the optical mirror 41, and the moveable mirror 42 reflects a second optical 62 signal back to the optical mirror 41 (see FIG. 3). The optical mirror 41 cooperates with the optical mirror 44 to transmit the first and second optical signals 60, 62 to the receiver device 50. Then the receiver device 50 determines an elapsed time 210 between receiver of the first and second optical signals 60, 62, and converts the elapsed time 210 into a distance between the object and the reference point.

The laser range finder 3 employs a switchable micro-mirror 30 to output optical signals to the fixed mirror 40 and the moveable mirror 42, which ensures that the laser range finder 3 can accurately measure the distance between the reference point and the object.

It is to be understood, however, that even though numerous characteristics and advantages of the embodiments have been set out in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

1. An optical device for measuring a distance between a reference point and an object, the optical device comprising:
an optical source for emitting an optical signal as one or more light beams;
a switchable micro-mirror for receiving the light beams, and selectively transmitting the optical signal to a fixed mirror and a moveable mirror; and
a receiver device for collecting the light beams reflected from the fixed mirror and the moveable mirror, respectively.

2. The optical device as claimed in claim 1, wherein the switchable micro-mirror comprises an optical micro-mirror and a micro-electromechanical system.

3. The optical device as claimed in claim 2, wherein the micro-electromechanical system supports the optical micro-mirror, and induces the switchable micro-mirror to mechanically deform.

4. The optical device as claimed in claim 3, wherein the switchable micro-mirror further comprises a substrate.

5. A laser range finder for measuring a distance of an object from a reference point, comprising:
a laser emitter for emitting light beams;
a switchable micro-mirror for receiving the light beams and selectively outputting the light beams in different directions;
a fixed mirror disposed at the reference point for receiving light beams output from the switchable micro-mirror and reflecting a first optical signal;
a moveable mirror disposed at the object for receiving light beams output from the switchable micro-mirror and reflecting a second optical signal; and
a receiver device for receiving the first and second optical signals, determining an elapsed time between receipt of the first and second optical signals, and converting the elapsed time into a distance between the object and the reference point.

6. The optical device as claimed in claim 5, wherein the switchable micro-mirror comprises an optical micro-mirror and a micro-electromechanical system.

7. The optical device as claimed in claim 6, wherein the micro-electromechanical system supports the optical micro-mirror, and induces the switchable micro-mirror to mechanically deform.

8. The optical device as claimed in claim 7, wherein the switchable micro-mirror further comprises a substrate.

9. A method for determining a distance of an object from a reference point, the method comprising:
emitting an optical signal and focusing the optical signal to a switchable micro-mirror;
selectively transmitting the optical signal to a fixed mirror disposed at the reference point and to a moveable mirror disposed at the object;
receiving a first optical signal reflected by the fixed mirror and a second optical signal reflected by the moveable mirror;
determining an elapsed time between receipt of the first optical signal and the second optical signal, and converting the elapsed time into a distance between the object and the reference point.

10. The method as claimed in claim 9, wherein the switchable micro-mirror comprises an optical micro-mirror and a micro-electromechanical system.

11. The method as claimed in claim 10, wherein the micro-electromechanical system supports the optical micro-mirror, and induces the switchable micro-mirror to mechanically deform.

12. The method as claimed in claim 11, wherein the switchable micro-mirror further comprises a substrate.
